(19) United States
(12) Patent Application Publication
(10) Pub. No.: US 2005/0094034 A1
(43) Pub. Date: May 5, 2005

(54) System and method for simultaneously scanning video for different size pictures

(76) Inventors: Sandeep Bhatia, Bangalore (IN); Srinivasa Mogathala Prabhakara Reddy, Bangalore (IN)

Correspondence Address: MCANDREWS HELD & MALLOY, LTD, 500 WEST MADISON STREET, SUITE 3400, CHICAGO, IL, 60661, US

(21) Appl. No.: 10/976,446

(22) Filed: Oct. 29, 2004

Related U.S. Application Data
(60) Provisional application No. 60/516,540, filed on Oct. 31, 2003.

(51) Int. Cl. H04N 7/01

(52) U.S. Cl. 348/581; 348/441

(57) ABSTRACT

Presented herein are system and method for simultaneously scanning video for different size pictures. In one embodiment, there is presented a method for providing a video output. The method comprises receiving a picture; scaling a picture to a first size; and scaling the picture to a second size. In another embodiment, there is presented a decoder system. The decoder system provides a video output and comprises an input, a first scalar, and a second scalar. The first input receives a picture. The first scalar scales the picture to a first size. The second scalar scales the picture to a second size.

### RELATED APPLICATIONS

This application claims priority to “SYSTEM, METHOD, AND APPARATUS FOR SIMULTANEOUSLY PROVIDING FULL SIZE VIDEO AND MASSIVELY SCALED DOWN VIDEO USING ICONIFICATION”, Provisional Application for U.S. patent, Ser. No. 60/516,540, (Attorney Docket No. 15146US01), filed Oct. 31, 2003, by Bhatia, et. al., which is incorporated herein by reference for all purposes.

This application is related to “SYSTEM, METHOD, AND APPARATUS FOR PROVIDING MASSIVELY SCALED DOWN VIDEO USING ICONIFICATION”, application for U.S. patent, Ser. No. ______, (Attorney Docket No. 15295US01), filed Oct. 29, 2004, by Bhatia, et. al., which is incorporated herein by reference for all purposes.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

There are number of different standards for the dimensions of video pictures. For example, standard definition television (SDTV) according to the National Television Standards Committee (NTSC) specifies a pictures size of 480 lines of 720 pixels. The phase alternate line (PAL) specifies picture sizes of 625 lines of pixels, while the SECAM standard specifies 819 lines of pixels. Additionally, high definition television (HDTV) according to the NTSC specifies a picture size of 1080 lines of 1920 pixels.

A decoder system usually includes what is known as a display engine for rendering the picture displayed on a video screen. A display engine renders graphics for the display, scales pictures, and feeds the pixels to the display device.

In certain applications, a video may be displayed on more than one display device. Additionally, the more than one display device may include different picture sizes. For example, the video display may be displayed on an HDTV screen as well as an SDTV screen.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Presented herein are system and method for simultaneously scanning video for different size pictures.

In one embodiment, there is presented a method for providing a video output. The method comprises receiving a picture; scaling a picture to a first size; and scaling the picture to a second size.

In another embodiment, there is presented a decoder system. The decoder system provides a video output and comprises an input, a first scalar, and a second scalar. The first input receives a picture. The first scalar scales the picture to a first size. The second scalar scales the picture to a second size.

These and other advantages and novel features of the present invention, as well as details illustrated embodiments thereof, will be more fully understood from the following description and drawings.

### BRIEF DESCRIPTION OF SEVERAL VIEWS OF THE DRAWINGS

FIG. 1 is a block diagram describing the encoding of video data in accordance with the MPEG-2 standard;

FIG. 2 is a block diagram of an exemplary video decoder in accordance with an embodiment of the present invention;

FIG. 3 is a block diagram of the display engine; and

FIG. 4 is a flow diagram for simultaneous display of HDTV and SDTV pictures in accordance with an embodiment of the present invention.

### DETAILED DESCRIPTION OF THE INVENTION

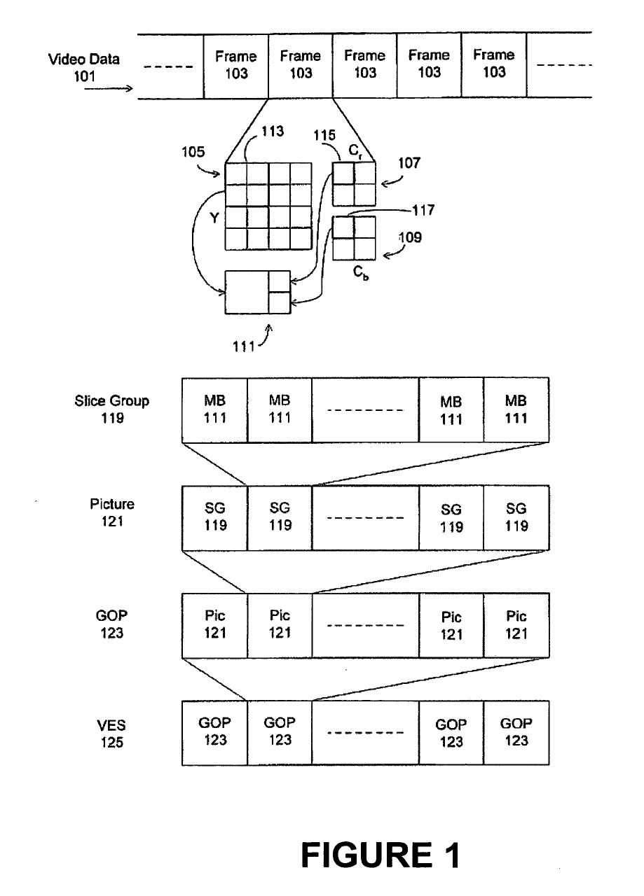

Referring now to FIG. 1 there is illustrated a block diagram of an exemplary Moving Picture Experts Group (MPEG) encoding process of video data 101, in accordance with an embodiment of the present invention. The video data 101 comprises a series of frames 103. Each frame 103 comprises two-dimensional grids of luminance Y, 105, chrominance red Cr, 107, and chrominance blue C_{b}, 109, pixels. The two-dimensional grids are divided into 8×8 blocks, where a group of four blocks or a 16×16 block 113 of luminance pixels Y is associated with a block 115 of chrominance red Cr, and a block 117 of chrominance blue C_{b} pixels. The block 113 of luminance pixels Y, along with its corresponding block 115 of chrominance red pixels Cᵣ, and block 117 of chrominance blue pixels C_{b} form a data structure known as a macroblock 111. The macroblock 111 also includes additional parameters, including motion vectors, explained hereinafter. Each macroblock 111 represents image data in a 16×16 block area of the image.

The data in the macroblocks 111 is compressed in accordance with algorithms that take advantage of temporal and spatial redundancies. For example, in a motion picture, neighboring frames 103 usually have many similarities. Motion causes an increase in the differences between frames, the difference being between corresponding pixels of the frames, which necessitate utilizing large values for the transformation from one frame to another. The differences between the frames may be reduced using motion compensation, such that the transformation from frame to frame is minimized. The idea of motion compensation is based on the fact that when an object moves across a screen, the object may appear in different positions in different frames, but the object itself does not change substantially in appearance, in the sense that the pixels comprising the object have very close values, if not the same, regardless of their position within the frame. Measuring and recording the motion as a vector can reduce the picture differences. The vector can be used during decoding to shift a macroblock 111 of one frame to the appropriate part of another frame, thus creating movement of the object. Hence, instead of encoding the new value for each pixel, a block of pixels can be grouped, and the motion vector, which determines the position of that block of pixels in another frame, is encoded.

Accordingly, most of the macroblocks 111 are compared to portions of other frames 103 (reference frames). When an appropriate (most similar, i.e. containing the same object(s)) portion of a reference frame 103 is found, the differences between the portion of the reference frame 103 and the macroblock 111 are encoded. The location of the portion in the reference frame 103 is recorded as a motion vector. The encoded difference and the motion vector form part of the data structure encoding the macroblock 111. In the MPEG-2 standard, the macroblocks ill from one frame 103 (a predicted frame) are limited to prediction from portions of no more than two reference frames 103. It is noted that frames 103 used as a reference frame for a predicted frame 103 can be a predicted frame 103 from another reference frame 103.

The macroblocks 111 representing a frame are grouped into different slice groups 119. The slice group 119 includes the macroblocks 111, as well as additional parameters describing the slice group. Each of the slice groups 119 forming the frame form the data portion of a picture structure 121. The picture 121 includes the slice groups 119 as well as additional parameters that further define the picture 121.

The pictures 121 are then grouped together as a group of pictures (GOP) 123. The GOP 123 also includes additional parameters further describing the GOP. Groups of pictures 123 are then stored, forming what is known as a video elementary stream (VES) 125. The VES 125 is then packetized to form a packetized elementary sequence. Each packet is then associated with a transport header, forming what are known as transport packets.

The transport packets can be multiplexed with other transport packets carrying other content, such as another video elementary stream 125 or an audio elementary stream. The multiplexed transport packets form what is known as a transport stream. The transport stream is transmitted over a communication medium for decoding and displaying.

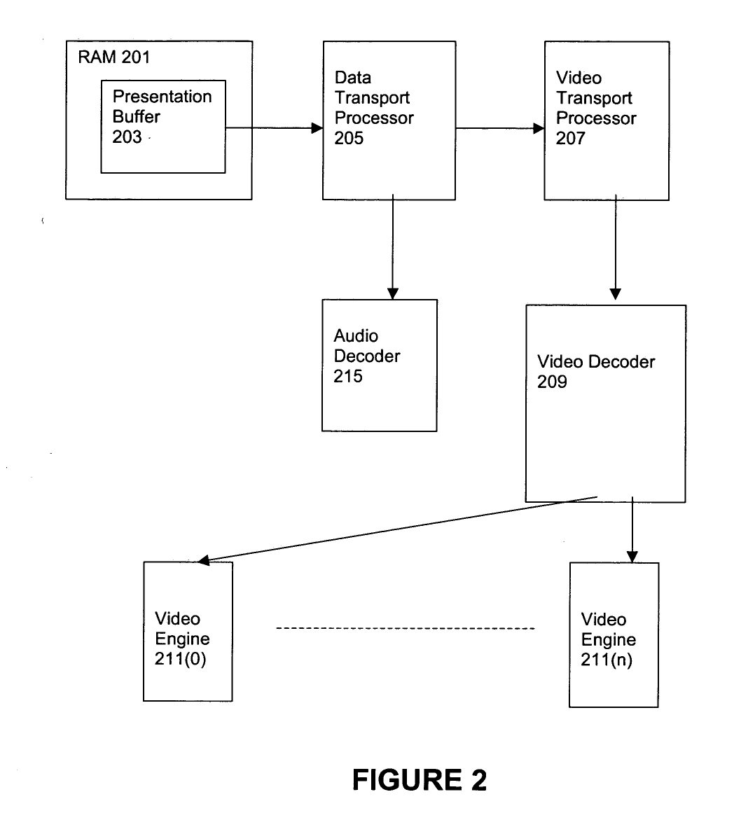

Referring now to FIG. 2 illustrates a block diagram of an exemplary circuit for decoding the compressed video data, in accordance with an embodiment of the present invention. Data is received and stored in a buffer 203 within a memory 201. The data can be received from either a communication channel or from a local memory, such as, for example, a hard disc or a DVD.

The data output from the buffer 203 is then passed to a data transport processor 205. The data transport processor 205 demultiplexes the transport stream into packetized elementary stream constituents, and passes the audio transport stream to an audio decoder 215 and the video transport stream to a video transport processor 207 and then to a video decoder 209. The audio data is then sent to the output blocks.

The video data is sent to one of a plurality of display engines 211(0) . . . 211(n). The display engines 211 scales the video picture, renders the graphics, and constructs the complete display. Each display engine 211(0) . . . 211(n) scales the video picture to a particular one of a plurality of sizes. According to certain aspects of the present invention, one of the display engines 211(0) scales the decoded pictures from the video decoder 209 to an SDTV size, while another of the display engines 211(1) scales the decoded pictures from the video decoder 209 to an HDTV size.

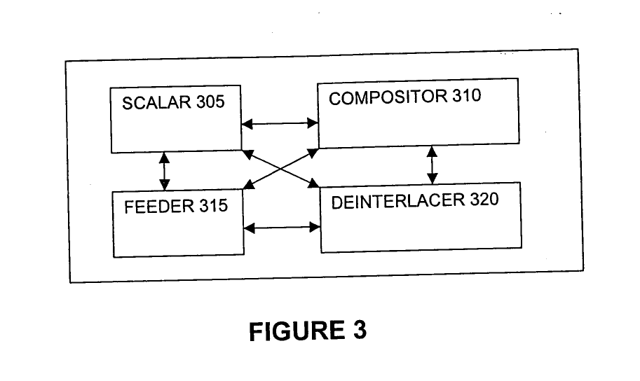

Referring now to FIG. 3, there is illustrated a block diagram of a display engine 211. The display engine 211 includes a scalar 305, a compositor 310, a feeder 315, and a deinterlacing filter 320. The feeder 315 rasterizes the pixels of the displayed picture and converts the format of the picture to the display format.

The scalar 305 for each display engine 211(0) . . . 211(n) can scale a picture 121 to a particular dimension. According to certain aspects of the present invention, one scalar 305, e.g., from display engine 211(0) can scale the decoded pictures from the video decoder 209 to an SDTV picture, while another scalar 305, e.g., from display engine 211(1) can scale the decoded pictures from the video decoder 209 to an HDTV picture.

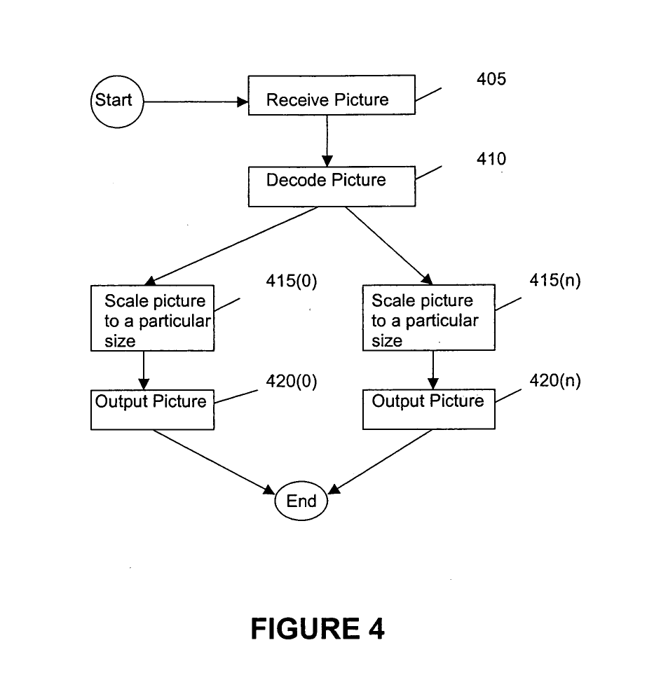

Referring now to FIG. 4, there is illustrated a flow diagram for simultaneously scanning a plurality of different sized pictures in accordance with an embodiment of the present invention.

At 405, the video decoder 209 receives a picture 121. The video decoder 209 decodes the picture 121 at 410. At 415 (0) . . . 415(n), each the scalars in the display engines 211(0) . . . 211(n) scale the picture 121 decoded by the video decoder 209 to a particular size associated with the display engine. At 420 (0) . . . 420(n), the display engines 211 (0) . . . 211(n) output the pictures 121 for display.

The inventions described herein may be implemented as a board level product, as a single chip, application specific integrated circuit (ASIC), or with varying levels of the system integrated on a single chip with other portions of the system as separate components. The degree of integration of the monitoring system may primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor can be implemented as part of an ASIC device wherein the memory storing instructions is implemented as firmware.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for providing a video output, said method comprising:
receiving a picture;
scaling a picture to a first size; and
scaling the picture to a second size.

2. The method of claim 1, wherein the first size is standard definition television and the second size is high definition television.

3. The method of claim 1, further comprising:
decoding the picture.

4. The method of claim 1, wherein scaling the picture to a first size and scaling the picture to a second size are substantially simultaneous.

5. A decoder system for providing a video output, said decoder system comprising:
an input for receiving a picture;
a first scalar for scaling the picture to a first size; and
a second scalar for scaling the picture to a second size.

6. The decoder system of claim 5, wherein the first size is standard definition television and the second size is high definition television.

7. The decoder system of claim 5, further comprising:
a video decoder for decoding the picture.

8. The decoder system of claim 5, wherein the first scalar scales the picture to a first size and the second scalar scales the picture to a second size substantially simultaneously.

9. The decoder system of claim 5, wherein the first scalar forms a portion of a first display engine and wherein the second scalar forms a portion of a second display engine.
